(19) United States
(12) Patent Application Publication
(10) Pub. No.: US 2001/0009206 A1
(43) Pub. Date: Jul. 26, 2001

(54) Vehicle load detection apparatus

(76) Inventor: Anthony Jack Lines, Rathmines (AU)

Correspondence Address: HOFFMAN WASSON & GITLER, 2361 JEFFERSON DAVIS HIGHWAY, SUITE 522, ARLINGTON, VA, 22202

(21) Appl. No.: 09/805,256

(22) Filed: Mar. 14, 2001

Related U.S. Application Data
(63) Continuation-in-part of application No. 08/897,288, filed on Jul. 21, 1997.

(51) Int. Cl. G01G 19/08

(52) U.S. Cl. 177/136

(57) ABSTRACT

A vehicle load detection apparatus which detects displacement between the chassis and an axle assembly of a motor vehicle to provide an indication of the weight supported by the axle assembly and which includes an actuator having a piston rod and a displacement detector having an operating member coupled to the piston rod. The displacement detector is inoperative when the piston is retracted, and is operative when the actuator is actuated to advance the piston road and detector operating member into engagement with the axle.

### CROSS REFERENCE TO RELATED APPLICATION

This application is a continuation-in-part application of application Serial No 08/897,288 filed Jul. 21, 1997, now abandoned.

### TECHNICAL FIELD

The present invention relates to heavy vehicles and other load carrying vehicles and in particular to apparatus for providing an indication of the weight or load carried by heavy or other load carrying vehicles.

### BACKGROUND OF THE INVENTION

Frequently load limits of heavy vehicle (including trailers) and other load carrying vehicles are exceeded. Overloading of a vehicle can lead to penalties from road authorities and in addition overloading detracts from the safety of the vehicle as it affects the handling of the vehicle particularly if there is excessive load on the front steering wheels. Whilst vehicle weighbridges are provided at some locations, this method of weighing is usually impractical as there are few weighbridges that are in close proximity to the load pickup which will operate during the hours of transport working. Mobile weighing devices known as slippers used by authorities to check loads on vehicles are rarely accurate because of the conditions in which they operate and are also of no benefit to the owner/operator of the vehicle in attempting to ensure that they are operating within safe load limits. Load cells are impractical or expensive as the installation of load cells involves alteration of the vehicle and provide a potential weakness.

Some other devices have been proposed in the past on vehicles to indicate to the operator of a vehicle that the weight carried by the vehicle is excessive. For example, U.S. Pat. No. 4,606,419 discloses a truck mounted load scale which uses hydraulic load cylinders which have piston rods contactable with a vehicle axle such that fluid expelled from the cylinders actuates a load indicating displacements cylinder located adjacent to the load cylinders. As the load indicating displacement cylinder is located beneath the vehicle tray, it is difficult if not impossible for a single operator who is loading the vehicle to determine the load on the vehicle. For example, an operator who drives a vehicle such as earth moving equipment onto the vehicle tray cannot determine the load upon the vehicle unless he alights from the equipment. A further disadvantage is that hydraulic fluid is used as the medium to indicate displacement and as hydraulic fluid consistency can vary according to the temperature, inconsistency of load readings can result. Yet a further disadvantage is that the Perini system relies on a linear deflection of the vehicle tray relative to the vehicle axle to provide a correct load reading however due to variations in spring systems of vehicles, accurate readings are not consistently achieved. A further problem which occurs is that of mechanical hysterisis which can vary the accuracy of readout by 5-20 % depending on the suspension system of a vehicle.

U.S. Pat. No. 3,151,692 to Dysart discloses another load measuring system in which movement of a ferromagnetic core through coils generates an electrical signal which is applied to an indicator gauge in the vehicle cab. A disadvantage of this system is that the load sensor continuously functions even when the vehicle is being driven on roads thus resulting is excessive wear. Further the indicator gauge is only able to be read by the vehicle driver and not easily externally from the load carrying vehicle.

U.S. Pat. No. 5,844,474 to Saling discloses a further device which comprises a vehicle overload sensor which indicates an overload situation by means of a visual or audible alarm. Overload is determined by a shock absorber type sensing device having a limit switch which is actuated upon detection of excessive weight on the vehicle. An audible and/or visual alarm in the vehicle is/are actuated upon detection of excessive loads. A disadvantage of this system is that the sensing device is permanently connected between the vehicle body or tray and axle resulting in excessive wear in the actuator. Furthermore, excess load conditions only are indicated and not actual load carried.

None of the prior art devices have the capability of storing information as to the load carried by the vehicle at a particular time or have the capability of allowing remote monitoring. Thus non of the prior art devices have a record of loading of the vehicle which may be important in the case of an accident and legal proceedings relative thereto.

### SUMMARY OF THE INVENTION

The present invention aims to overcome or substantially ameliorate one or more of the above disadvantages by providing a vehicle load detection and indicating apparatus which can be applied to any load carrying vehicle and which will prove reliable and effective in use in indicating to a user an overload situation and/or load carried by a vehicle.

The present invention thus provides in a first aspect, an apparatus to indicate the magnitude of weight carried by a vehicle, the vehicle having a body supported on a wheel assembly by a resilient suspension, said body being movable relative to said wheel assembly upon a weight being applied to said vehicle body, said apparatus comprising:

linear detector means to detect displacement between said body and said wheel assembly and to produce an output in accordance with said relative movement, said detector means having an operating arm;

actuator means having an extended and retracted position and operable for moving said operating arm of said detector means between an inoperative configuration spaced from said wheel assembly and an operative configuration in engagement with said wheel assembly in which said detector means can detect the displacement between said body and said wheel assembly;

indicator means responsive to said output of said detector means to provide a user with an indication of weight supported by the vehicle; and

electronic control means for controlling said actuator means, said control means including means for selectively actuating said actuating means to cause said actuator means to move to said extended attitude and means for moving said actuator means to said retracted position.

Preferably, the actuator means comprises a piston and cylinder actuator, the piston having a piston rod which is movable between a retracted position maintaining the detector means in its inoperative configuration and an extended position maintaining the detector means in its operative configuration. Most preferably, the actuator means comprises a pneumatic actuator and solenoid valve means is provided for supplying air to the actuator, the solenoid valve means being controlled by the control means to effect extension and retraction of the piston rod.

The indicator means may comprise first indicator means for indicating that a predetermined weight is being approached and second indicator means for indicating that a predetermined weight has been exceeded. The indicator means may alternatively or additionally comprises visual indicating means such as an indicator lamp arranged externally of said vehicle. Alternatively or additionally, the indicator means may comprises display means for displaying the weight carried by the vehicle.

The control means may include processor means for processing the input from the detector means and for providing an output to said display means adjusted in accordance with the hysterisis of the resilient suspension. The control means may include a keypad having a plurality of keys or pads with actuation of the actuator means beings effected by operation of one of the keys or pads.

Most preferably, the detector means comprises a linear variable resistor. Preferably also, the operating arm of said detector means (linear variable resistor) is fixed for movement with the piston rod of said actuator. Alternatively, the detector means may comprise other forms of linearly variable transducer such as a variable capacitor or inductance.

In a further aspect, the present invention provides apparatus for measuring a load carried by a vehicle of the type having a body supported on a wheel assembly by a resilient suspension, said apparatus comprising:

linear detector means for detecting relative displacement between said body and wheel assembly as a result of load on said vehicle and for providing an output proportional to said relative displacement, said linear detector means including a linearly movable operating arm,

actuator means having an extendable and retractable actuating member,

means coupling said operating arm of said detector means to said actuating member of said actuator means;

control means for said apparatus including means for actuating said actuator means to extend said actuating member and move said operating member of said detector means to an operative position in engagement with said wheel assembly whereby said detector means may detect the displacement between the body and wheel assembly, and means for actuating said actuator means to retract said actuating member and move said operating member of said detector means to an inoperative position away from said wheel assembly; and

display means responsive to the output of said detector means for displaying load carried by said vehicle.

The load measuring apparatus suitably includes alarm means, and the control means triggers the alarm means when overload is sensed by the detector means. The alarm means may comprise visible warning means arranged externally of the vehicle and/or an audible alarm.

In a further aspect, the present invention provides apparatus for measuring a load carried by a vehicle of the type having a body supported on a wheel assembly by a resilient suspension, said apparatus comprising:

linear variable resistor means for detecting relative displacement between said body and wheel assembly as a result of load on said vehicle and for providing a variable resistance output proportional to said relative displacement, said linear variable resistor including an operating member,

pneumatic actuator means having an extendable and retractable actuating member,

solenoid valve means for supplying air to said pneumatic actuator means

means coupling said operating member of said detector means to said actuating member of said pneumatic actuator means;

control means for said apparatus including means for actuating said solenoid to supply air to said pneumatic actuator means to extend said actuating member and move said operating member of said variable resistor means to an operative position in engagement with said wheel assembly whereby said variable resistor means may provide an output proportional to the displacement between the body and wheel assembly, and for supplying air to said pneumatic actuator means to retract said actuating member and move said operating member of said variable resistor means to an inoperative position away from said wheel assembly; and

display means responsive to said the output of said variable resistor means for displaying load supported by said vehicle.

Preferably, the control means includes processor means for processing the output of the variable resistor means and adjusting the output for display by the display means in accordance with the hysterises of the resilient suspension.

The vehicle may comprise a vehicle supported by multiple wheel assemblies and respective actuator means and linear variable resistor means may be associated with each wheel assembly. The processor means may include a plurality of channels associated with respective variable resistor means to enable load on each wheel assembly to be displayed by the display means upon switching through respective channels.

The apparatus may also include memory means for storing the load reading on the or each wheel assembly as detected by the variable resistor means. The apparatus may further include means for transmitting the load reading on the or each wheel assembly to a remote location.

### BRIEF DESCRIPTION OF THE DRAWINGS

A preferred form of the present invention will now be described by way of example with reference to the accompanying drawings wherein:

FIG. 1 is a schematic top plan view of the chassis of the motor lorry fitted with the load detection apparatus of the invention;

FIG. 2 is a schematic elevation of a portion of the front suspension of a motor lorry,

FIG. 3 is a schematic elevation of a portion of the rear suspension of the motor lorry;

FIGS. 4 to 6 are schematic circuit diagrams to be employed in a load or weight detection apparatus employed in the motor lorry shown in FIGS. 1 to 3;

FIG. 7 illustrates the load detector and associated actuator according an a further embodiment of the invention;

FIG. 8 is a schematic block diagram of the control system for the weight detecting apparatus of the invention;

FIG. 9 illustrates the housing for the controller of the control system for use in the cabin of the load carrying vehicle; and

FIG. 10 is a schematic rear elevational view of a semi-trailer body situated above a pit which comprises a load simulation apparatus.

### DETAILED DESCRIPTION OF THE PREFERRED EMBODIMENTS

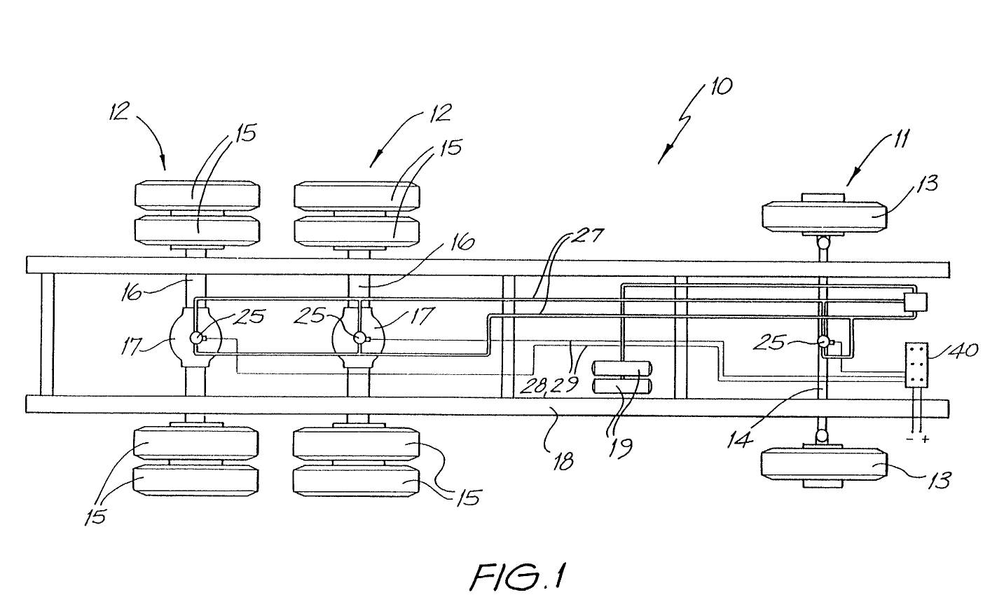

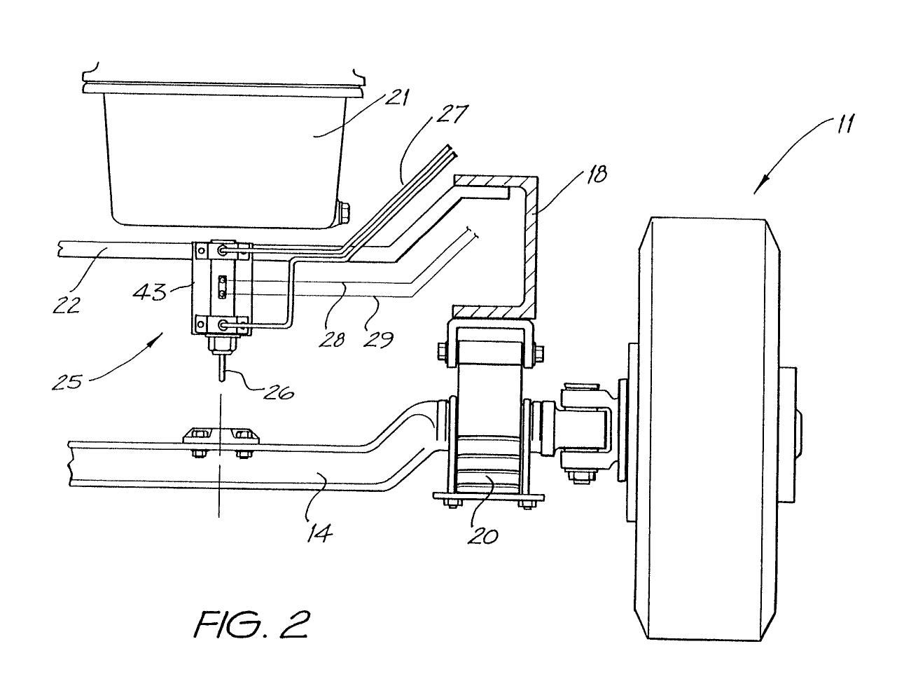

Referring to the drawings and firstly to FIG. 1, there is schematically depicted the chassis 10 of a heavy-vehicle in this case a motor lorry however it should be appreciated that the vehicle could also be a trailer to be associated with a prime mover. The chassis 10 is supported by a front wheel assembly 11 and two rear wheel assemblies 12. The front wheel assembly 11 includes a pair of front wheels 13 supported by a front axle beam 14 as is more fully shown with its associated suspension in FIG. 2.

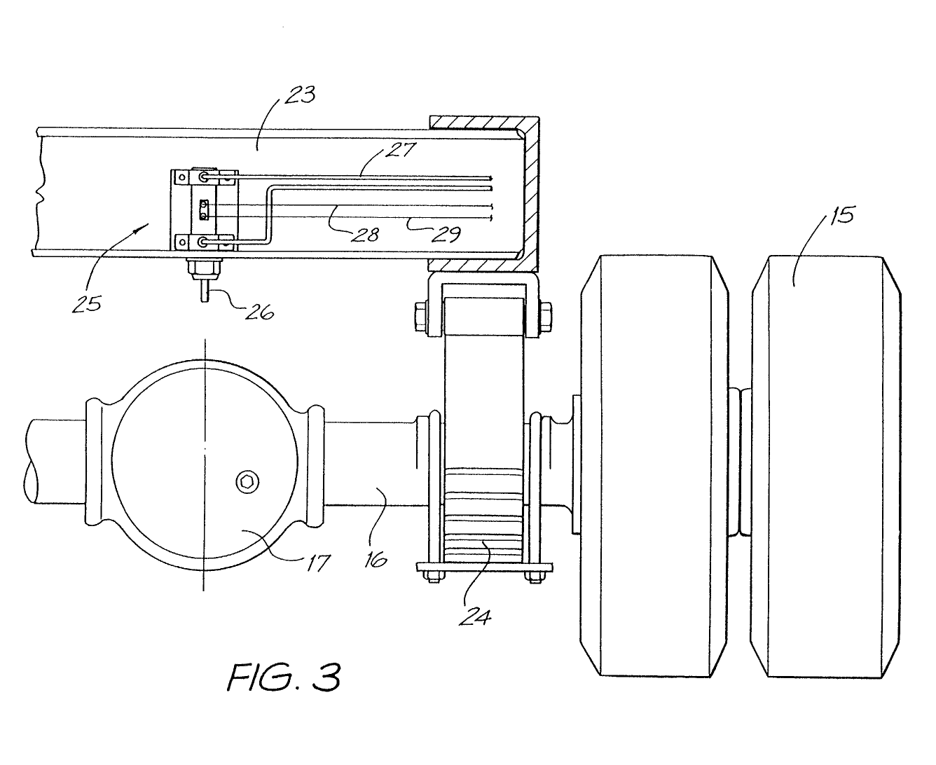

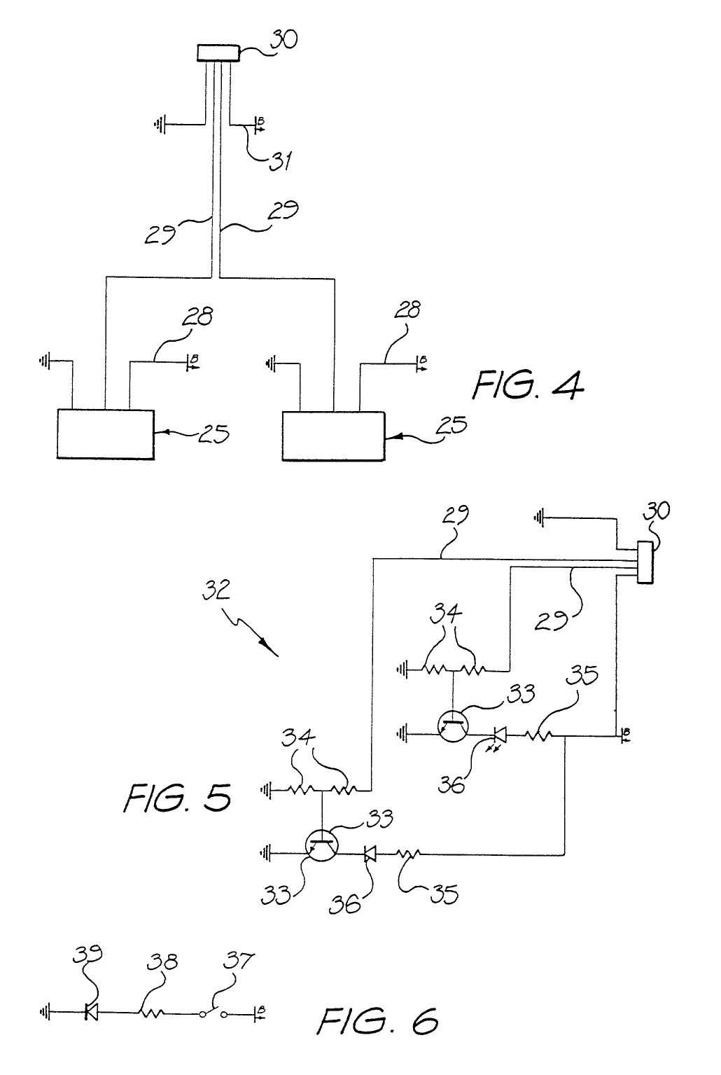

Each rear wheel assembly 12 as shown more clearly in FIG. 3 includes a plurality of wheels 15 supported on an axle 16 having a central differential housing 17. The chassis 10 includes a pair of opposite longitudinally extending parallel chassis beams 18 and supports on the chassis 10 compressed air tanks 19 which receive air under pressure from a compressor associated with the engine of the vehicle. Each of the wheel assemblies 11 and 12 supports the chassis 10 (and any load delivered thereto or supported thereon) by a resilient suspension. That resilient suspension may be leaf springs, coil springs, air bags or any other suitable means. In the present instance the front wheel assembly 11 includes leaf springs 20 extending between the chassis beams 18 and the front axle beam 14. Similarly the rear wheel assemblies 12 are supported from the chassis beams 18 by leaf springs 24. Extending transversely beneath the sump 21 of the engine of the vehicle and between the chassis beams 18 is a support rail 22. Similarly transverse cross beams 23 are connected to and extend between the chassis beams 18 at a position substantially vertically above the axles 16.

As the vehicle is loaded, the chassis 10 moves relative to the wheel assemblies 11 and 12. More particularly, the rail 22 moves towards the beam 14 and the transverse cross beams 23 move closer to the differential housings 17 as a result of the resilient deformation of the leaf springs 20 and 24. The relative movement between the chassis 10 and the wheel assemblies 11 and 12 is indicative of the weight carried by the vehicle.

Associated with each wheel assembly 11 and 12 is a displacement detection device shown generally at 25. Each device 25 includes a pneumatic actuator which comprises a piston and cylinder and which can receives air from the air tanks 19, the piston including a piston rod 26 which is movable between an extended position at which it can be engaged by the differential housing 17 or beam 14, and a retracted position in which it cannot be engaged. The movement between these two positions is controlled by the delivery of air under pressure to the cylinder of the device 25. When the piston rod 26 is in its extended position and is engaged by the beam 14 or a differential housing 17, it is caused to move relative to its associated cylinder. The device 25 is a displacement detection device in that a signal or reading is produced as a result of relative movement between the piston rod 26 and its associated cylinder. In the present embodiment two signals are produced. However in that regard it should be appreciated that other configurations are contemplated in that a continuous signal or reading may be produced, which signal is indicative of the relative movement or alternatively the device 25 may produce discrete signals or readings when certain relative displacements are reached. In the present instance a first signal or reading is produced after a predetermined displacement between the piston rod 26 and the associated cylinder has occurred. If a greater relative displacement is detected a second signal or reading is then produced. The first signal provides an indication to the driver that a predetermined load limit is being approached. The second signal provides an indication that the load has been reached or has been exceeded.

In the present instance, the cylinder of the device 25 is associated with a pair of air lines 27 which deliver air to opposite ends of the cylinder to move the piston rod 26 in opposite directions. Also extending from the device 25 are electric wires or cables 28 and 29. The wire 28 may supply power, and the wire 29 may conduct the signals. The wires 29 associated with each device 25 terminate in a plug 30 which is also connected to the power supply (battery) via the wires 31. The plug 30 connects the device 25 to a circuit 32 (see FIG. 5) which is to provide a visual indication (via a light) for the driver to determine when a predetermined load is being reached or has been exceeded. The circuit 32 includes a pair of transistor switch circuits each including transistors 33 and connected to respective wires 29. A pair of resistors 34 provide a voltage dividing circuit for switching the transistors 33. When current from the wires 29 exceeds a certain value, the transistors 33 are switched to permit current to flow through the resistor 35 and the light emitting diode 36 in the collector circuit of the transistors 33. When the diode 36 emits light the driver knows that the load limit is being approached or is being exceeded.

Power is delivered to the circuit 32 by means of a switch 37, a resistor 38 and a light emitting diode 39 which advises the driver when power is being delivered to the circuit 32, that is when the apparatus is energised to provide an indication of the weight being carried by the vehicle (see FIG. 6). The light emitting diodes 36 and 38 may be mounted in a panel 40 (see FIG. 1) in the cabin of the vehicle. By being able to retract the piston rod 26, the device 25 can be isolated during normal use of the vehicle, thereby eliminating undue wear on the device 25.

The above described preferred embodiment has the advantages of advising the driver when the weight limits are being approached and therefore the driver is aware and is then in a position to prevent overloading of the vehicle. This increases the safety of the vehicle and minimises wear and tear on the vehicle.

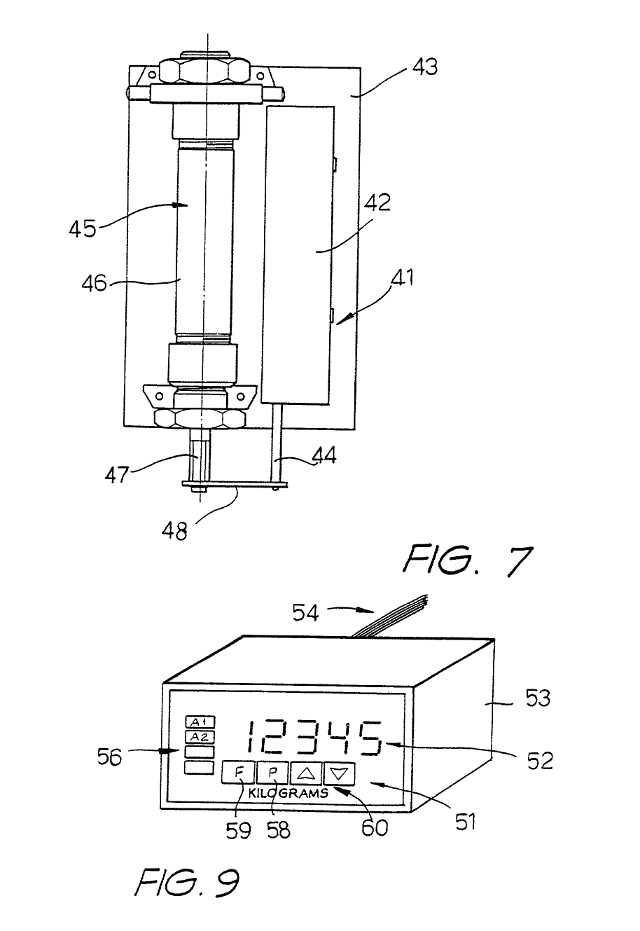

FIG. 7 illustrates an alternative arrangement for measuring the relative displacement between the chassis 10 of the motor vehicle and the axle assemblies 11 and/or 12 which includes a LVDT (linear variable displacement transducer) which in this embodiment is in the form of a linear variable slide resistor device or linear potentiometer 41. The device 41 has a body 42 supported on a mounting plate 43 which is mounted to the chassis 10 of the vehicle for example on the arm 18 or beam 23 in the position of the devices 25 shown in FIGS. 2 and 3. The device 41 also includes a movable slider coupled to an operating arm 44, the movement of which relative to the body 42 varies the resistance of the device 41. The mounting plate 43 also carries a pneumatic actuator 45 which includes a cylinder 46 and a piston movable in the cylinder 46 which includes a piston rod 47 projecting from the cylinder 46. The operating arm 44 of the device 41 is attached by a cross arm 48 to the distal end of the piston rod 47 so as to be movable with the piston rod 47. As a further alternative, the LVDT could be formed within or directly upon the cylinder 46 or piston rod 47. It will be apparent that extension and retraction of the piston rod 47 will result in movement of the operating arm 44 of the device 41 in opposite directions to provide a variable readout from the device 41, in the case of a variable resistor, a variable resistance. As the device 41 is a linear device, the readout from the device 41 varies linearly with movement of the operating arm 44 towards and away from the axles.

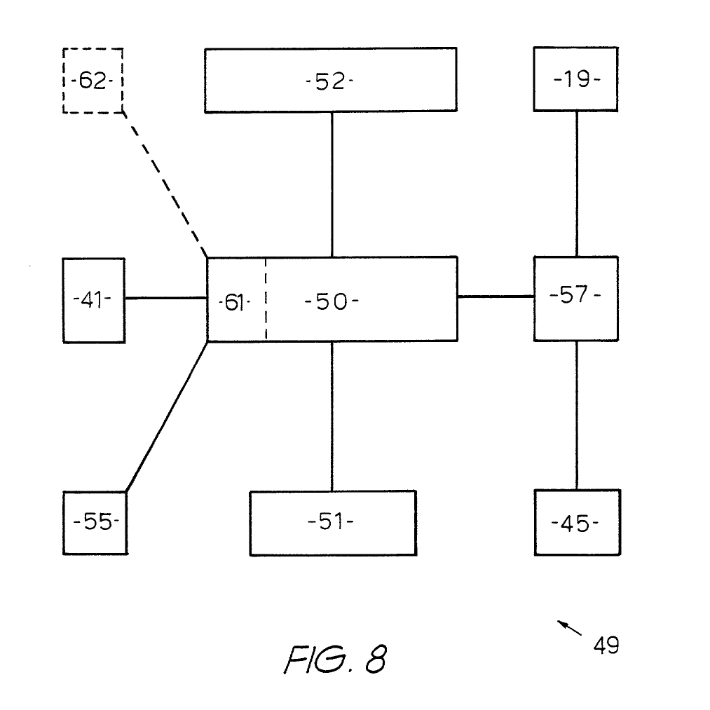

FIG. 8 illustrates in block diagram form, an electronic control system 49 for use with the device 41 and actuator 45, the system including an arithmetic multi-channel digital processor 50 whose functions are initiated by a keypad 51. A display 52 such as a liquid crystal display or LCD display is also connected to the processor 50 to display weight numerically or other information. Alternatively the display 52 may be a bar graph. The keypad 51 and display 52 are arranged on the front panel of a housing 53 (see FIG. 9) in which is located the processor 50 and other associated circuitry. The housing 53 is usually located in or on the dashboard of a vehicle or other location which enables the display 52 to be easily monitored. Cables 54 extend from the housing 53 to connect the control system 49 to the weight sensing device 41 and control operation of the pneumatic actuator 45 and to a power supply usually the battery of the vehicle. The processor 50 is also connected to an alarm which preferably is in the form of a lamp 55 or other visible warning means but which may also be in the form of a buzzer or other audible alarm. Most preferably, the lamp 55 is located externally of the vehicle such as on the top of the cab of the vehicle (see for example its positioning in FIG. 11) so as to be able to monitored externally whilst loading of the vehicle. The front panel of the housing 53 also carries a series of alarm indicators 56 in the form of lamps or LED'S. Air supply to the actuator 45 is controlled by a two-way solenoid valve 57 which controls the supply of compressed air from the vehicle compressed air tanks 19. A first key 58 of the keypad 51 comprises a power key such that when depressed, the processor 50 generates a control signal to effect the application of current to the solenoid of the solenoid valve 56 suitably via a relay within the housing 53 which will cause air to be applied to the one end of the cylinder 46 of the actuator 45 to cause the piston rod 47 to advance the operating arm 44 of the device 41 downwardly to its datum position where the piston rod 47 or member 44 contacts the adjacent axle or axle support 14 or differential housing 17 (or a striker plate thereon) of the vehicle. Upon contact, the piston rod 47 will stop advancing but apply a biasing force to hold the operating arm 44 in that position until a load is applied.

At this position (when cessation of movement of the operating arm 44 is sensed by the processor 50) the display 52 will automatically announce TARE and then zero will appear indicating that the datum zero point has been set and the system is ready to weigh loads applied to the vehicle. The keypad 51 also includes a function key 59 for display of other parameters and for set up purposes as described further below. Usually, a heavy vehicle as described with reference to FIG. 1 will have a number of displacement detecting devices 41 with associated actuators 45 fitted to cooperate with respective wheel assemblies of the vehicle such as the wheel assemblies 11 and 12 of FIG. 1. Up down keys 60 enable the processor 50 to be switched through different channels corresponding to different axles of the vehicle such that the load on each axle can be selectively displayed on the display 52. Each channel may also be programmed during set up by use of the keypad 51 to an overload limit such that if that limit is exceeded on loading, the warning lamp 55 (and/or audible alarm) as well as the alarm lamps 56 on the housing 53 will be actuated. Preferably, set point relays for each channel are located in the housing 53 to effect actuation of the warning lamp 55 (or audible alarm) upon receiving an overload signal from the processor 50. This is particularly useful when a single operator is loading the vehicle as the overload limit can be set on a particular axle and the operator when loading the vehicle will be aware if overload is occurring on a particular axle. This will enable positing of a load on the vehicle at its optimum position where overload does not occur on any axle. Similarly, if the vehicle is a low loader and excavation or other equipment is being driven onto the low loader, the driver of the low loader will be aware if the external warning lamp 55 illuminates that too much load is placed on a particular axle and thus may reposition the equipment on the low loader until the warning lamp 55 turns off. The operator can then toggle through the other channels to ensure that excess load is not occurring on any axle.

After loading is completed, the system 49 may be turned off by using the power key 58 or alternatively, the system 49 may be timed to turn off automatically. In the either case, a control signal is generated by the processor 50 to actuate the solenoid valve 57 in the other direction to apply air from the tanks 19 to the other end of the cylinder 46 of the actuator 45 to retract the piston rod 47 and connected operating arm 44.

The load measuring system may also be used when the vehicle is operating on the road in the same manner as described above if it is desirable to measure load when travelling or in certain situations such as for measuring load on the front axle down a hill under brakes.

The processor 50 may also include a memory 61 to record details of the load on each axle and the date and time that the load is recorded. This enables the loading of the vehicle to be monitored by downloading of the information stored in the memory 61. Thus in the event of an accident, the history of the loading of the vehicle can be viewed enabling a determination of whether the vehicle has been overloaded. The memory 61 can also store load information determined during operation of the vehicle as described above such as load on the front axle when the vehicle is being driven down a hill and is under brakes. This information is particularly useful for designers of vehicles who can assess vehicle performance under load and make appropriate design changes. Vehicles fitted with the load detection apparatus of the present invention can be monitored remotely for example by transmitting the information read from the load detection devices which may be stored in the memory 61. For this purpose, a transmitter 62 may be provided in the housing 53 and connected to the processor 50. This information may be transmitted to a road authority or to the vehicle fleet owner so that vehicle loading can be monitored on demand. The transmitter 62 may be actuated remotely to enable the loading to be checked at any time. A global positioning system may also be provided so that the geographical location of the vehicle can be also transmitted by the transmitter. Transmission can be either a local transmission or via satellite.

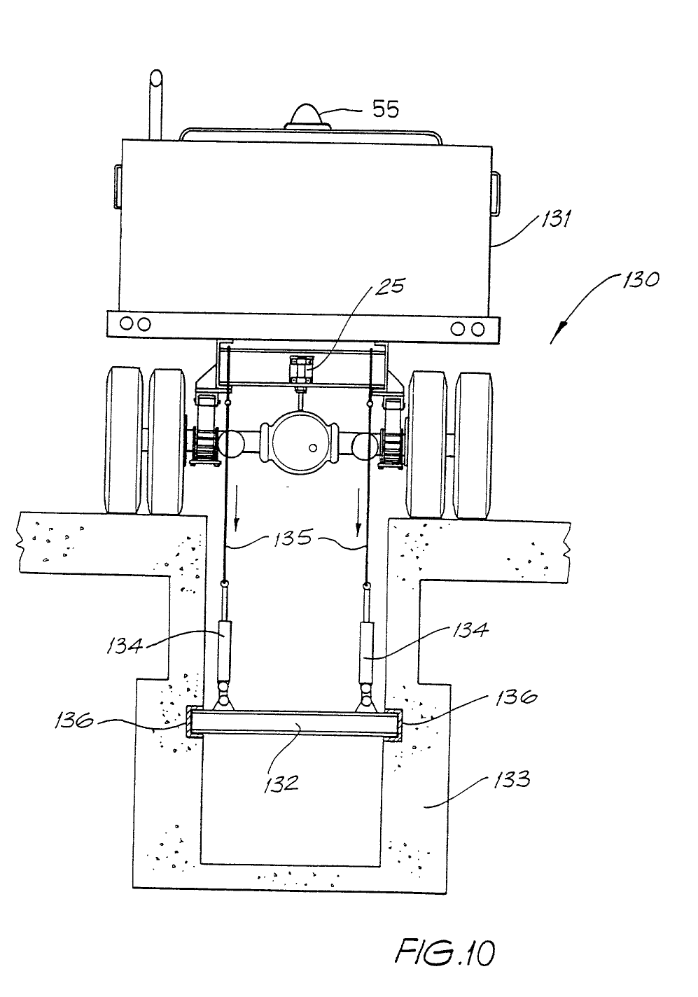

To overcome the problem of mechanical hysterisis which occurs with springs, the load measuring system is calibrated using the apparatus of FIG. 10. Mechanical hysterisis occurs due to frictional forces encountered upon compression of springs and thus load applied to a spring is not proportional to distance. Springs which exhibit excessive amounts of delay are commonly found on Bogie drive axles or Bogie trailers. This hysterisis effect is caused by two steel surfaces rubbing together continuously

Thus errors in reading of the displacement detection device which relies of distance to indicate weight can occur. Those errors can be up to 5% in the case of coil springs and 20% in the case of leaf springs. Those frictional forces in the case of load carrying motor vehicles are not released until the vehicle moves. Thus if a vehicle is loaded without calibration to take into account mechanical hysterisis, the displayed weight reading will be less than the actual weight carried resulting in possible overload.

The load simulation apparatus 130 shown in FIG. 10 as applied to a vehicle (truck) 131. The apparatus comprises a pulling beam 132 extending transversely across a pit 133 over which the truck 131 is parked. The transverse ends of the pulling beam 132 are received within respective recessed C-beams 136 which extend longitudinally of the pit 133 in the opposed side walls thereof. A pair of pulldown cylinders 134 each associated with hydraulic pump feed lines (not shown) are each attached to the beam 132 and pull down on respective slings 135. These slings 135 are attached to the chassis of the truck 131 so as to simulate a load within the trailer of the truck 13 1.

By use of the apparatus as shown in FIG. 10, the load measuring system can be calibrated so as to correctly indicate the weight applied to the axle. For this purpose, the weight readings at the display 52 can be read for a range of measured loads applied by the pull down rams 134. This information is stored in a memory (such as in the memory 61) connected to or within the processor 50 to generate a calibration curve. After calibration has occurred, the sensed load applied to the vehicle is adjusted in accordance with the calibration curve so that the correct load applied is displayed at the display 52. During the calibration process, the function key 59 and up down keys 60 can be used to enter various parameters for each axle for example to set overload limits for each axle, to set the automatic retract time for the solenoid 57, to vary the display or for any other parameter.

Whilst the above has been given by way of illustrative embodiment of the invention, all such variations and modifications thereto as would be apparent to persons skilled in the art are deemed to fall within the broad scope and ambit of the invention as defined by the appended claims.

I claim:

1. An apparatus to indicate the magnitude of weight carried by a vehicle, the vehicle having a body supported on a wheel assembly by a resilient suspension, said body being movable relative to said wheel assembly upon a weight being applied to said vehicle body, said apparatus comprising:
linear detector means to detect displacement between said body and said wheel assembly and to produce an output in accordance with said relative movement, said detector means having an operating arm;
actuator means having an extended and retracted position and operable for moving said operating arm of said detector means between an inoperative configuration spaced from said wheel assembly and an operative configuration in engagement with said wheel assembly in which said detector means can detect the displacement between said body and said wheel assembly;
indicator means responsive to said output of said detector means to provide a user with an indication of weight supported by the vehicle; and
electronic control means for controlling said actuator means, said control means including means for selectively actuating said actuating means to cause said actuator means to move to said extended attitude and means for moving said actuator means to said retracted position.

2. The apparatus of claim 1, wherein said actuator means comprises a piston and cylinder actuator and having a piston rod which is movable between a retracted position maintaining said detector means in its inoperative configuration and an extended position maintaining said detector means in its operative configuration.

3. The apparatus of claim 2 wherein said actuator means comprises a pneumatic actuator and including solenoid valve means for supplying air to said actuator, said solenoid valve means being controlled by said control means to effect extension and retraction of said piston rod.

4. The apparatus of claim 1, wherein said indicator means comprises first indicator means for indicating that a predetermined weight is being approached and second indicator means for indicating that a predetermined weight has been exceeded.

5. The apparatus of claim 1 wherein said indicator means comprises an indicator lamp arranged externally of said vehicle.

6. The apparatus of claim 1 wherein said indicator means comprises display means for displaying the weight carried by said vehicle.

7. The apparatus of claim 6 wherein said control means includes processor means, for processing the input from said detector means and for providing an output to said display means adjusted in accordance with the hysterisis of said resilient suspension.

8. The apparatus of claim 7 wherein said control means includes a keypad having a plurality of keys or pads and wherein actuation of said actuator means is effected by operation of one of said keys or pads.

9. The apparatus of claim 1, wherein said detector means comprises a linear variable resistor.

10. The apparatus of claim 2 wherein said operating arm of said detector means is fixed for movement with said piston rod of said actuator.

11. Apparatus for measuring a load carried by a vehicle of the type having a body supported on a wheel assembly by a resilient suspension, said apparatus comprising:
linear detector means for detecting relative displacement between said body and wheel assembly as a result of load on said vehicle and for providing an output proportional to said relative displacement, said linear detector means including a linearly movable operating arm,
actuator means having an extendable and retractable actuating member,
means coupling said operating arm of said detector means to said actuating member of said actuator means;
control means for said apparatus including means for actuating said actuator means to extend said actuating member and move said operating member of said detector means to an operative position in engagement with said wheel assembly whereby said detector means may detect the displacement between the body and wheel assembly, and means for actuating said actuator means to retract said actuating member and move said operating member of said detector means to an inoperative position away from said wheel assembly; and
display means responsive to the output of said detector means for displaying load carried by said vehicle.

12. The apparatus of claim 11 and including alarm means, said control means triggering said alarm means when overload is sensed by said detector means.

13. The apparatus of claim 12 wherein said alarm means comprises visible warning means arranged externally of said vehicle.

14. Apparatus for measuring a load carried by a vehicle of the type having a body supported on a wheel assembly by a resilient suspension, said apparatus comprising:
linear variable resistor means for detecting relative displacement between said body and wheel assembly as a result of load on said vehicle and for providing a variable resistance output proportional to said relative displacement, said linear variable resistor means including an operating member,
pneumatic actuator means having an extendable and retractable actuating member,
solenoid valve means for supplying air to said pneumatic actuator means
means coupling said operating member of said detector means to said actuating member of said pneumatic actuator means;
control means for said apparatus including means for actuating said solenoid to supply air to said pneumatic actuator means to extend said actuating member and move said operating member of said variable resistor means to an operative position in engagement with said wheel assembly whereby said variable resistor means may provide an output proportional to the displacement between the body and wheel assembly, and for supplying air to said pneumatic actuator means to retract said actuating member and move said operating member of said variable resistor means to an inoperative position away from said wheel assembly; and
display means responsive to said the output of said variable resistor means for displaying load supported by said vehicle.

15. The apparatus of claim 14 wherein said control means includes processor means for processing the output of said variable resistor means and adjusting said output for display by said display means in accordance with the hysterises of said resilient suspension.

16. The apparatus of claim 15 wherein said vehicle comprises a vehicle supported by multiple wheel assemblies and wherein respective said actuator means and linear variable resistor means are associated with each said wheel assembly and where said processor means includes a plurality of channels associated with respective said variable resistor means to enable load on each wheel assembly to be displayed by said display means upon switching through respective said channels.

17. The apparatus of claim 16 and including memory means for storing the load reading on the or each said wheel assembly as detected by said variable resistor means.

18. The apparatus of claim 16 and including means for transmitting the load reading on the or each said wheel assembly to a remote location.
